(19) United States
(12) Patent Application Publication
(10) Pub. No.: US 2025/0199203 A1
(43) Pub. Date: Jun. 19, 2025

(54) THERMOPLASTIC RESIN AND OPTICAL MEMBER CONTAINING SAME

(71) Applicant: TEIJIN LIMITED, Osaka (JP)

(72) Inventors: Yoshihiro ISHIHARA, Osaka (JP); Keisuke SATO, Osaka (JP)

(73) Assignee: TEIJIN LIMITED, Osaka (JP)

(21) Appl. No.: 18/849,773

(22) PCT Filed: Feb. 10, 2023
(86) PCT No.: PCT/JP2023/004638

§ 371 Date: Sep. 23, 2024

(30) Foreign Application Priority Data
Mar. 25, 2022 (JP) 2022-049672

(51) Int. Cl. G02B 1/04; C08G 64/16; C08G 64/30

(52) U.S. Cl. CPC G02B 1/041; C08G 64/1608; C08G 64/307

(57) ABSTRACT

The purpose of the present invention is to provide: a polycarbonate resin which can satisfy all of a refractive index, an Abbe number, heat resistance, and birefringence; and an optical member containing the same. This thermoplastic resin contains repeating units represented by formula (1), formula (2) and formula (3), contains 60 mol % or more of repeating units represented by formula (1), and has a refractive index of more than 1.600 and not more than 1.660. (In formula (1), R¹ to R⁴ each independently denote a hydrogen atom or a hydrocarbon group having 1-10 carbon atoms.) (In formula (3), n falls within the range 1-8, R⁵ and R⁶ each independently denote a hydrogen atom or a hydrocarbon group having 1-10 carbon atoms, and R⁷ denotes a hydrogen atom or an alkyl group having 1-3 carbon atoms.)

### FIELD

The present invention relates to a novel thermoplastic resin and an optical member formed thereof, particularly an optical lens.

### BACKGROUND

The present invention relates to a thermoplastic resin and an optical member comprising the same.

There has been a strong demand for the improvement of low birefringence and aberration correction ability in plastic imaging lenses used in devices such as smartphones. Conventionally, aberrations have been corrected in such imaging lenses by a combination of a plurality of lenses having mutually different optical characteristics (refractive index and Abbe number) and a combination of lens shapes.

In recent years, lens units have increasingly been produced by combining resins with high refractive indices and low Abbe numbers and cycloolefin-based resins with low refractive indices and high Abbe numbers. In order to further produce lens units having high performance, resins with medium refractive indices and medium Abbe numbers have been used, thereby expanding the range of lens design and making the fine-tuning of lenses for achieving advanced performance possible. Therefore, the demand for resins with medium refractive indices and medium Abbe numbers having a refractive index of about 1.600 to 1.660 has been increasing. When transparent resins for optics are used as optical lenses, in addition to refractive index and Abbe number, transparency, heat resistance and low birefringence are required. Thus, there is a drawback that the balance of characteristics of a resin limits the use location thereof. For example, since there are drawbacks such as low heat resistance and high birefringence for polystyrene, low heat resistance for poly-4-methylpentene, low glass transition temperature and low heat resistance for polymethyl methacrylate, and high birefringence for polycarbonates composed of bisphenol A, the use locations thereof are limited.

PTL 1 to 3 disclose polycarbonate resin compositions comprising a compound having a fluorene skeleton.

### CITATION LIST

### Patent Literature

[PTL 1] Japanese Unexamined Patent Publication (Kokai) No. 10-101786
[PTL 2] WO 2017/010318
[PTL 3] Japanese Unexamined Patent Publication (Kokai) No. 2020-19922

### SUMMARY

### Technical Problem

The polycarbonate resins disclosed in PTL 1 and 2 propose a copolymer resin of a compound having a fluorene skeleton and one other component. Although it is possible to satisfy any of refractive index, Abbe number, heat resistance, and birefringence, satisfying all thereof is difficult.

Since the polycarbonate resin disclosed in PTL 3 has a small content ratio of a compound having a fluorene skeleton, it is possible to satisfy any of refractive index. Abbe number, heat resistance, and birefringence. However, satisfying all thereof is difficult.

The present invention has an object of providing a polycarbonate resin that satisfies all of refractive index, Abbe number, heat resistance, and birefringence and an optical member comprising the same.

### Solution to Problem

The present inventors have discovered that the above object can be achieved by the present invention having the following aspects.

### <<Aspect 1>>

A thermoplastic resin comprising repeating units represented by Formula (1), Formula (2), and Formula (3), wherein the repeating unit represented by the Formula (1) is 60 mol % or greater and a refractive index is greater than 1.600 and 1.660 or less:

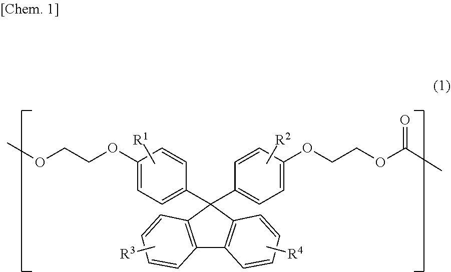

where in the Formula (1), R¹ to R⁴ each independently represent a hydrogen atom or a hydrocarbon group having 1 to 10 carbon atoms, and

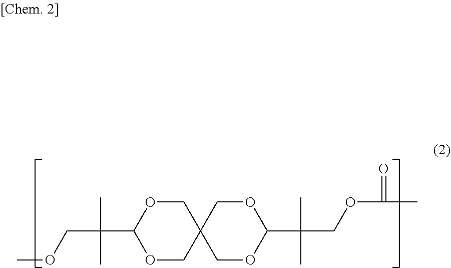

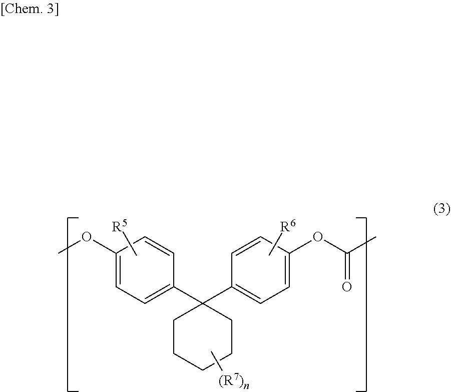

where in the Formula (3), n is in a range of 1 to 8; R⁵ and R₆ each independently represent a hydrogen atom or a hydrocarbon group having 1 to 10 carbon atoms; and R⁷ represents a hydrogen atom or an alkyl group having 1 to 3 carbon atoms.

### <<Aspect 2>>

The thermoplastic resin according to Aspect 1, wherein the repeating unit of the Formula (1) is 60 mol % or greater and 80 mol % or less.

### <<Aspect 3>>

The thermoplastic resin according to Aspect 1 or 2, wherein R¹ to R⁴ in the Formula (1) are each a hydrogen atom.

### <<Aspect 4>>

The thermoplastic resin according to any one of Aspects 1 to 3, wherein the repeating unit of the Formula (3) is a repeating unit derived from 4,4′-(3,3,5-trimethylcyclohexylidene)bisphenol.

### <<Aspect 5>>

The thermoplastic resin according to any one of Aspects 1 to 4, which has a glass transition temperature of 130 to 160° C.

### <<Aspect 6>>

The thermoplastic resin according to any one of Aspects 1 to 5, which has an absolute value of orientation birefringence of 3.0×10⁻³ or less.

### <<Aspect 7>>

The thermoplastic resin according to any one of Aspects 1 to 5, which has an absolute value of orientation birefringence of 1.0×10⁻³ or less.

### <<Aspect 8>>

The thermoplastic resin according to any one of Aspects 1 to 7, which has an Abbe number of 24.0 to 29.0.

### <<Aspect 9>>

An optical member comprising the thermoplastic resin according to any one of Aspects 1 to 8.

### <<Aspect 10>>

The optical member according to Aspect 9, which is an optical lens.

### <Thermoplastic Resin>

The thermoplastic resin of the present invention comprises repeating units represented by the above Formula (1), the above Formula (2), and the above Formula (3), wherein the repeating unit represented by the above Formula (1) is 60 mol % or greater. In addition, the thermoplastic resin of the present invention has a refractive index of greater than 1.600 and 1.660 or less.

The present inventors have discovered that a thermoplastic resin containing 60 mol % or greater of the repeating unit represented by the above Formula (1) exhibits a medium refractive index and a medium Abbe number useful in producing optical lens units, and have further discovered that by copolymerization with the above Formulas (2) and (3), not only refractive index and Abbe number but also heat resistance and birefringence can all be satisfied, leading to the present application.

### <Thermoplastic Resin Structure>

R¹ to R⁴ in the above Formula (1) each independently represent a hydrogen atom or a hydrocarbon group having 1 to 10 carbon atoms. Examples of the hydrocarbon group can include an alkyl group, a cycloalkyl group, and an aryl group.

Examples of the alkyl group include a methyl group, an ethyl group, a propyl group, an isopropyl group, a butyl group, and a t-butyl group. A methyl group or an ethyl group is preferable.

Examples of the cycloalkyl group include a cyclopropyl group, a cyclobutyl group, a cyclopentyl group, a cyclohexyl group, and a bicyclo[1.1.1]pentanyl group.

Examples of the aryl group include a phenyl group, a tolvl group, a naphthyl group, and a xylyl group. A phenyl group is preferable.

R¹ to R⁴ are each independently preferably a hydrogen atom, a methyl group, or a phenyl group, and more preferably a hydrogen atom or a phenyl group. It is even more preferable that R¹ and R² each independently be a hydrogen atom or a phenyl group, and R³ and R⁴ a hydrogen atom.

The repeating unit represented by the above Formula (1) is preferably a repeating unit derived from 9,9-bis(4-(hydroxyethoxy)phenyl) fluorene or 9,9-bis(4-(hydroxyethoxy)-3-phenylphenyl) fluorene, and more preferably a repeating unit derived from 9,9-bis(4-(hydroxyethoxy)phenyl) fluorene.

The thermoplastic resin of the present invention can comprise preferably 60 mol % to 99 mol %, more preferably 60 mol % to 85 mol %, even more preferably 60 mol % to 80 mol %, particularly preferably 65 mol % to 80 mol %, and most preferably 70 mol % to 80 mol % of the repeating unit of the above Formula (1).

When the repeating unit represented by the above Formula (1) is included in the above range, refractive index and birefringence can be satisfied.

The repeating unit represented by the above Formula (2) is a repeating unit derived from 3,9-bis(2-hydroxy-1,1-dimethylethyl)-2,4,8,10-tetraoxaspiro[5.5]undecane.

The thermoplastic resin of the present invention can comprise preferably 1 mol % to 35 mol %, more preferably 5 mol % to 30 mol %, even more preferably 10 mol % to 25 mol %, and particularly preferably 10 mol % to 20 mol % of the repeating unit of the above Formula (2).

In the above Formula (3), n represents a range of 1 to 8, and is preferably 1 to 5, more preferably 1 to 3, and even more preferably 3. In addition, R′ and Re each independently represent a hydrogen atom or a hydrocarbon group having 1 to 10 carbon atoms. Examples of the hydrocarbon group can include an alkyl group, a cycloalkyl group, and an aryl group.

Examples of the alkyl group include a methyl group, an ethyl group, a propyl group, an isopropyl group, a butyl group and a t-butyl group. A methyl group or an ethyl group is preferable.

Examples of the cycloalkyl group include a cyclopropyl group, a cyclobutyl group, a cyclopentyl group, a cyclohexyl group, and a bicyclo[1.1.1]pentanyl group.

Examples of the aryl group include a phenyl group, a tolyl group, a naphthyl group, and a xylyl group. A phenyl group is preferable.

R⁵ and R⁶ are each independently preferably a hydrogen atom, a methyl group, or a phenyl group, more preferably a hydrogen atom or a phenyl group, and even more preferably a hydrogen atom.

R⁷ represents a hydrogen atom or an alkyl group having 1 to 3 carbon atoms, and is preferably a methyl group or an ethyl group, and more preferably a methyl group.

When the substituents of R⁵ and R⁶ are as described above, the amount of the above Formula (3) introduced can be increased without significantly increasing the refractive index, and thus high heat resistance can be achieved. In addition, when the substituent of R⁷ is as described above, even higher heat resistance can be achieved.

The repeating unit represented by the above Formula (3) is preferably a repeating unit derived from 4,4″-(3,3,5-trimethylcyclohexylidene)bisphenol, 4.4″-cyclohexylidenebisphenol, or 4,4′-(3-methylcyclohexylidene)bisphenol, and more preferably a repeating unit derived from 4,4″-(3,3,5-trimethylcyclohexylidene)bisphenol or 4,4″-cyclohexylidenebisphenol.

The thermoplastic resin of the present invention can comprise preferably 1 mol % to 35 mol %, more preferably 5 mol % to 30 mol %, even more preferably 5 mol % to 20 mol %, and particularly preferably 5 mol % to 15 mol % of the repeating unit of the above Formula (3).

When the repeating units represented by the above Formulas (2) and (3) are included in the above ranges, refractive index, Abbe number, heat resistance, and birefringence can be satisfied.

The thermoplastic resin of the present invention may comprise a repeating unit other than the repeating units represented by the above Formula (1), the above Formula (2), and the above Formula (3), in a range in which the above advantageous effect of the present invention is obtained. Examples of dihydroxy compounds resulting in such a repeating unit include ethylene glycol, propanediol, butanediol, pentanediol, hexanediol, heptanediol, octanediol, nonanediol, tricyclo[5.2.1.02,6]decanedimethanol, cyclohexane-1,4-dimethanol, decalin-2,6-dimethanol, norbornane dimethanol, pentacyclopentadecane dimethanol, cyclopentane-1,3-dimethanol, isosorbide, isomannide, isoidide, hydroquinone, resorcinol, 2,2-bis(4-hydroxyphenyl)propane, 2,2-bis(3-methyl-4-hydroxyphenyl)propane, 1,1-bis(4-hydroxyphenyl)-1-phenylethane, bis(4-hydroxyphenyl)diphenylmethane, 1,3-bis(2-(4-hydroxyphenyl)-2-propyl)benzene, bis(4-hydroxyphenyl)sulfone, bis(4-hydroxyphenyl)sulfide, biphenol, bisphenol fluorene, and biscresol fluorene. Such a repeating unit may be 10 mol % or less of all repeating units.

The thermoplastic resin of the present invention preferably has no phenolic hydroxyl group at the terminals. Specifically, when the monomer providing the repeating unit represented by the above Formula (3) is polymerized and bonded to a terminal, the terminal group is a phenolic hydroxyl group. Therefore, it is preferable that the amount of terminal phenolic hydroxyl groups in the thermoplastic resin be reduced by using, for example, an amount of carbonic acid diester in excess to the raw material dihydroxy compound during polymerization so that a terminal has a phenyl group. The ratio of terminal phenolic hydroxyl groups can be determined as:

Terminal phenolic hydroxyl group ratio=(amount of terminal phenolic hydroxyl groups/amount of total terminals)×100. Note that, total terminals consist of terminal phenolic hydroxyl groups, terminal alcoholic hydroxyl groups, and terminal phenyl groups.

Although not limited to this example, the terminal phenolic hydroxyl group ratio can be specifically determined by the method as follows.

(1) Terminal phenolic hydroxyl groups are observed by ¹H NMR measurement of the thermoplastic resin, and an integral of the corresponding peak is taken and set as 1. At this time, the integrated intensity (A) for one proton of the fluorene structure is simultaneously determined from the integrated intensities of the peaks at positions 4 and 5 of the fluorene structure derived from the above Formula (1).

When no terminal phenolic hydroxyl group peaks are observed, the terminal phenolic hydroxyl group ratio is naturally 0.

(2) The average degree of polymerization of the thermoplastic resin is determined from the number average molecular weight obtained by GPC measurement of the thermoplastic resin and the molecular weight and mol ratio of each repeating unit, and from the mol % of the above Formula (1) and the integrated intensity (A), an integrated intensity (B) of the ¹H NMR spectrum of the terminal is determined in the following formula.

(B)=(A)×100×2/([mol % of the above Formula (1)]×average degree of polymerization)

(3) The terminal phenolic hydroxyl group ratio is determined as 1/(B)×100.

The terminal phenolic hydroxyl group ratio relative to the total terminals of the thermoplastic resin of the present invention is preferably 30% or less. 20% or less, 15% or less, 10% or less, 5% or less, 3% or less, 1% or less, or 0.5% or less.

### <Thermoplastic Resin Physical Properties>

The refractive index of the thermoplastic resin of the present invention, when measured at temperature: 20° C. and wavelength: 587.56 nm, is preferably greater than 1.600 and 1.660 or less, more preferably greater than 1.600 and 1.650 or less, even more preferably greater than 1.600 and 1.630 or less, particularly preferably greater than 1.600 and 1.620 or less, and especially preferably over 1.610 and 1.620 or less.

The Abbe number of the thermoplastic resin of the present invention is preferably 24.0 to 29.0, more preferably 25.0 to 29.0, even more preferably 24.0 to 28.0, particularly preferably 24.0 to 28.0, and most preferably 24.0 to 27.0.

The Abbe number (vd) is calculated at temperature: 20° C. and refractive indices at wavelengths: 486.13 nm, 587.56 nm, and 656.27 nm, using the following formula.

vd=(nd−1)/(nF−nC)
nd: refractive index at wavelength of 587.56 nm
nF: refractive index at wavelength of 486.13 nm
nC: refractive index at wavelength of 656.27 nm

The specific viscosity of the thermoplastic resin of the present invention is preferably 0.12 to 0.32, and more preferably 0.18 to 0.30. When the specific viscosity is 0.12 to 0.32, the balance of moldability and strength is excellent.

For the measurement method of specific viscosity, the specific viscosity (ηSP) at 20° C. of a solution having 0.7 g of the thermoplastic resin dissolved in 100 ml of methylene chloride is measured using an Ostwald viscometer and calculated from the following formula.

ηSP=(t−t₀)/₀

[t₀ is number of seconds to drop methylene chloride, and tis number of seconds to drop the sample solution.]

The absolute value of orientation birefringence (Δn) of the thermoplastic resin of the present invention is preferably 3.0×10⁻³ or less, more preferably 2.0×10⁻³ or less, even more preferably 1.0×10⁻³ or less, particularly preferably 0.6×10⁻³ or less, and most preferably 0.4×10⁻³ or less.

When the absolute value of orientation birefringence is the above value or less, there is no large effect on chromatic aberration, and thus performance according to optical design can be maintained. The orientation birefringence is measured at a wavelength of 589 nm after stretching a cast film having a thickness of 100 μm obtained from the thermoplastic resin two-fold at Tg+10° C.

In the thermoplastic resin of the present invention, the total light transmittance relative to a thickness of 1 mm is preferably 80% or greater, more preferably 85% or greater, and particularly preferably 88% or greater.

The saturated water absorption of the thermoplastic resin of the present invention may be 0.10% to 0.70%, 0.20% to 0.70%, or 0.30% to 0.65%.

The glass transition temperature of the thermoplastic resin of the present invention is preferably 130° C. to 160° C., more preferably 135° C. to 155° C., and particularly preferably 140° C. to 150° C.

Examples of the thermoplastic resin of the present invention include polycarbonate comprising carbonate structures represented by Formula (1), Formula (2), and Formula (3) in repeating units, and polyester carbonate comprising an ester structure in a repeating unit in addition to the repeating units represented by Formula (1). Formula (2), and Formula (3). Among these examples, a polycarbonate is preferable from the view of heat resistance and wet heat resistance.

### <Manufacturing Method of Polycarbonate Resin>

The polycarbonate resin of the present invention is manufactured by a method comprising a reaction means known per se for manufacturing a conventional polycarbonate resin, for example, reacting a dihydroxy compound with a carbonate precursor such as a carbonic acid diester. The basic means for the manufacturing method will be briefly described as follows.

A transesterification reaction using a carbonic acid diester as a carbonate precursor is carried out by stirring while heating a predetermined proportion of a dihydroxy component with a carbonic acid diester in an inert atmosphere and distilling the generated alcohol or phenol. The reaction temperature varies depending on the boiling point of the generated alcohol or phenol, but is normally in a range of 120 to 300° C. The reaction is carried out to completion under reduced pressure from an initial stage while distilling the generated alcohol or phenol. In addition, a capping agent or an antioxidant may be added as needed.

Examples of the carbonic acid diester used in the transesterification reaction include esters of optionally substituted aryl groups having 6 to 12 carbon atoms or aralkyl groups. Diphenyl carbonate, ditolyl carbonate, bis(chlorophenyl) carbonate, and m-cresyl carbonate are specifically exemplified. Among these examples, diphenyl carbonate is particularly preferable. The use amount of diphenyl carbonate, relative to 1 mol of dihydroxy compound in total, is preferably 0.95 to 1.10 mol, and more preferably 0.98 to 1.04 mol.

In order to accelerate the polymerization rate in the melt polymerization method, a polymerization catalyst can be used. Examples of such a polymerization catalyst include alkali metal compounds, alkaline earth metal compounds, and nitrogen-containing compounds.

As such compounds, organic acid salts, inorganic salts, oxides, hydroxides, hydrides, alkoxides, and quaternary ammonium hydroxides of alkali metals and alkaline earth metals are preferably used. These compounds can be used individually or in combination.

As alkali metal compounds, sodium hydroxide, potassium hydroxide, cesium hydroxide, lithium hydroxide, sodium hydrogen carbonate, sodium carbonate, potassium carbonate, cesium carbonate, lithium carbonate, sodium acetate, potassium acetate, cesium acetate, lithium acetate, sodium stearate, potassium stearate, cesium stearate, lithium stearate, sodium borohydride, sodium benzoate, potassium benzoate, cesium benzoate, lithium benzoate, disodium hydrogen phosphate, dipotassium hydrogen phosphate, dilithium hydrogen phosphate, disodium phenyl phosphate; disodium salts, dipotassium salts, dicesium salts, and dilithium salts of bisphenol A, and sodium salts, potassium salts, cesium salts, and lithium salts of phenol are exemplified.

As alkaline earth metal compounds, magnesium hydroxide, calcium hydroxide, strontium hydroxide, barium hydroxide, magnesium carbonate, calcium carbonate, strontium carbonate, barium carbonate, magnesium diacetate, calcium diacetate, strontium diacetate, and barium diacetate are exemplified.

Examples of nitrogen-containing compounds include quaternary ammonium hydroxides having an alkyl or aryl group, such as tetramethylammonium hydroxide, tetraethylammonium hydroxide, tetrapropylammonium hydroxide, tetrabutylammonium hydroxide, and trimethylbenzylammonium hydroxide. Bases or basic salts, such as tetramethylammonium borohydride, tetrabutylammonium borohydride, tetrabutylammonium tetraphenylborate, and tetraphenylammonium tetraphenylborate, are exemplified.

Examples of the additional transesterification catalyst include salts of zinc, tin, zirconium, lead, titanium, germanium, antimony, and osmium. For example, zinc acetate, zinc benzoate, zinc 2-ethylhexanoate, tin(II) chloride, tin(IV) chloride, tin(II) acetate, tin(IV) acetate, dibutyltin dilaurate, dibutyltin oxide, dibutyltin dimethoxide, zirconium acetylacetonate, zirconium oxyacetate, zirconium tetrabutoxide, lead(II) acetate, or lead(IV) acetate, titanium(IV) tetrabutoxide is used. Any of the catalysts used in WO 2011/010741 and Japanese Unexamined Patent Publication (Kokai) No. 2017-179323 may be used.

A catalyst consisting of aluminum or a compound thereof and a phosphorus compound may be used. In that case, the catalyst relative to 1 mol of dihydroxy component is preferably 80 μmol to 1000 μmol, more preferably 90 μmol to 800 μmol, and even more preferably 100 μmol to 600 μmol.

Examples of aluminum salts can include organic acid salts and inorganic acid salts of aluminum. Examples of organic acid salts of aluminum can include carboxylates of aluminum, and can specifically include aluminum formate, aluminum acetate, aluminum propionate, aluminum oxalate, aluminum acrylate, aluminum laurate, aluminum stearate, aluminum benzoate, aluminum trichloroacetate, aluminum lactate, aluminum citrate, and aluminum salicylate. Examples of inorganic acid salts of aluminum can include aluminum chloride, aluminum hydroxide, aluminum hydroxide chloride, aluminum carbonate, aluminum phosphate, and aluminum phosphonate. Examples of aluminum chelate compounds can include, aluminum acetylacetonate, aluminum acetyl acetate, aluminum ethyl acetoacetate, and aluminum ethyl acetoacetate diisopropoxide.

Examples of the phosphorus compound can include phosphonic acid-based compounds, phosphinic acid-based compounds, phosphine oxide-based compounds, phosphonous acid-based compounds, phosphinous acid-based compounds, and phosphine-based compounds. Among these, examples can specifically include phosphonic acid-based compounds, phosphinic acid-based compounds, and phosphine oxide-based compounds, and can particularly include phosphonic acid-based compounds.

The use amount of the polymerization catalyst, relative to 1 mol of dihydroxy component, is preferably 0.1 μmol to 500 μmol, more preferably 0.5 μmol to 300 μmol, and even more preferably 1 μmol to 100 μmol.

A catalyst deactivator can be added in a later stage of the reaction. As catalyst deactivators to be used, known catalyst deactivators are used effectively, and among these, ammonium salts and phosphonium salts of sulfonic acid are preferable. Further, salts of dodecylbenzenesulfonic acid such as dodecylbenzenesulfonic acid tetrabutylphosphonium salt, and salts of paratoluenesulfonic acid such as paratoluenesulfonic acid teterabutylammonium salt are preferable.

As esters of sulfonic acid, methyl benzenesulfonate, ethyl benzenesulfonate, butyl benzenesulfonate, octyl benzenesulfonate, phenyl benzenesulfonate, methyl paratoluenesulfonate, ethyl paratoluenesulfonate, butyl paratoluenesulfonate, octyl paratoluenesulfonate, and phenyl paratoluenesulfonate are preferably used. Among these, dodecylbenzenesulfonic acid tetrabutylphosphonium salt is most preferably used.

For the use amount of catalyst deactivator, when at least one polymerization catalyst is selected from alkali metal compounds and/or alkaline earth metal compounds, preferably a proportion of 0.5 to 50 mol, more preferably a proportion of 0.5 to 10 mol, and even more preferably a proportion of 0.8 to 5 mol per mol of the catalyst can be used.

### <Manufacturing Method of Polyester Carbonate Resin>

The thermoplastic resin of the present invention may be a polyester carbonate resin. The polyester carbonate resin is manufactured by a method comprising a reaction means known per se for manufacturing a conventional polyester carbonate resin, for example, subjecting a dihydroxy compound to a polycondensation reaction with a carbonate precursor such as a carbonic acid diester and a dicarboxylic acid or an ester-forming derivative thereof.

In a reaction of a dihydroxy compound and a dicarboxylic acid or an acid chloride thereof with phosgene, the reaction is carried out in a nonaqueous system in the presence of an acid binder and a solvent. As the acid binder, for example, pyridine, dimethylaminopyridine, or a tertiary amine is used. As the solvent, for example, a halogenated hydrocarbon such as methylene chloride or chlorobenzene is used. As a molecular weight modifier, for example, it is desirable that a capping agent such as phenol or p-tert-butylphenol be used. The reaction temperature is normally 0 to 40° C., and the reaction time is preferably several minutes to 5 hours.

In a transesterification reaction, a dihydroxy compound, a dicarboxylic acid or a diester thereof, and a bisaryl carbonate are mixed in an inert gas atmosphere and reacted under reduced pressure at normally 120 to 350° C., preferably 150 to 300° C. The degree of pressure reduction is changed stepwise, and the pressure is ultimately reduced to 133 Pa or less to distill a generated alcohol out of the system. The reaction time is normally about 1 to 4 hours. In addition, a polymerization catalyst can be used to promote a reaction in the transesterification reaction. As such a polymerization catalyst, it is preferable that an alkali metal compound, an alkaline earth metal compound, or a heavy metal compound be used as a main component, and a nitrogen-containing basic compound be further used as an auxiliary component, as needed.

Examples of the alkali metal compound include sodium hydroxide, potassium hydroxide, lithium hydroxide, sodium hydrogen carbonate, potassium hydrogen carbonate, lithium hydrogen carbonate, sodium carbonate, potassium carbonate, lithium carbonate, sodium acetate, potassium acetate, lithium acetate, sodium stearate, potassium stearate, lithium stearate; sodium salts, potassium salts, and lithium salts of bisphenol A; sodium benzoate, potassium benzoate, and lithium benzoate. Examples of the alkaline earth metal compounds include calcium hydroxide, barium hydroxide, magnesium hydroxide, strontium hydroxide, calcium hydrogen carbonate, barium hydrogen carbonate, magnesium hydrogen carbonate, strontium hydrogen carbonate, calcium carbonate, barium carbonate, magnesium carbonate, strontium carbonate, calcium acetate, barium acetate, magnesium acetate, strontium acetate, calcium stearate, barium stearate, magnesium stearate, and strontium stearate.

Examples of the nitrogen-containing compound include tetramethylammonium hydroxide, tetraethylammonium hydroxide, tetrabutylammonium hydroxide, trimethylbenzylammonium hydroxide, trimethylamine, triethylamine, dimethylbenzylamine, triphenylamine, and dimethylaminopyridine.

As the additional transesterification catalyst, the catalysts recited as transesterification catalysts in the above manufacturing method of a polycarbonate can be used in the same manner.

When the thermoplastic resin of the present invention is polyester carbonate, after the polymerization reaction is completed, in order to ensure heat stability and hydrolytic stability, the catalyst may be removed or deactivated. Generally, the method of deactivating a catalyst is suitably carried out by adding a known acidic substance. Specifically, esters such as butyl benzoate; aromatic sulfonic acids such as p-toluenesulfonic acid; aromatic sulfonates such as butyl p-toluenesulfonate and hexyl p-toluenesulfonate; phosphoric acids such as phosphorous acid, phosphoric acid, and phosphonic acid, phosphites such as triphenyl phosphite, monophenyl phosphite, diphenyl phosphite, diethyl phosphite, di-n-propyl phosphite, di-n-butyl phosphite, di-n-hexyl phosphite, dioctyl phosphite, and monooctyl phosphite; phosphates such as triphenyl phosphate, diphenyl phosphate, monophenyl phosphate, dibutyl phosphate, dioctyl phosphate, and monooctyl phosphate; phosphonic acids such as diphenylphosphonic acid, dioctylphosphonic acid, and dibutylphosphonic acid; phosphonates such as diethyl phenylphosphonate; phosphines such as triphenylphosphine and bis(diphenylphosphino)ethane; boric acids such as boric acid and phenylboric acid; aromatic sulfonic acid salts such as dodecylbenzenesulfonic acid tetrabutylphosphonium salt; organic halides such as stearyl chloride, benzoyl chloride, and p-toluenesulfonyl chloride; alkyl sulfates such as dimethyl sulfate; and organic halides such as benzyl chloride are suitably used as the substance. These deactivators are used in a proportion of 0.01 to 50 mol, and preferably in a proportion of 0.3 to 20 mol relative to 1 mol in catalyst amount. When less than 0.01 mol relative to 1 mol in catalyst amount, the deactivation effect is insufficient, which is not preferable. When more than 50 mol relative to 1 mol in catalyst amount, heat resistance is lowered and a molded body is easily discolored, which is not preferable.

After the catalyst is deactivated, a step of devolatilizing and removing a low-boiling-point compound in the thermoplastic resin at a pressure of 13.3 to 133 Pa and a temperature of 200 to 320° C. may be provided.

### <Thermoplastic Resin Composition>

An additive such as a mold release agent, a heat stabilizer, an ultraviolet absorber, a bluing agent, an antistatic agent, a flame retardant, a plasticizer, a filler, an antioxidant, a photostabilizer, a polymeric metal deactivator, a lubricant, a surfactant, or an antibacterial agent can be appropriately added, as needed, to the thermoplastic resin of the present invention for use as a resin composition. Examples of specific mold release agents and heat stabilizers preferably include those described in the WO 2011/010741 pamphlet.

As a particularly preferable mold release agent, stearic acid monoglyceride, stearic acid triglyceride, pentaerythritol tetrastearate, or a mixture of stearic acid triglyceride and stearyl stearate is preferably used. The amount of the ester in the mold release agent, when the mold release agent is set to 100% by weight, is preferably 90% by weight or greater, and more preferably 95% by weight or greater. The mold release agent blended in the thermoplastic resin, relative to 100 parts by weight of the thermoplastic resin, is preferably in a range of 0.005 to 2.0 parts by weight, more preferably in a range of 0.01 to 0.6 parts by weight, and even more preferably in a range of 0.02 to 0.5 parts by weight.

Examples of the heat stabilizer include phosphorus-based heat stabilizers, sulfur-based heat stabilizers, and hindered phenol-based heat stabilizers.

As a particularly preferable phosphorus-based heat stabilizer, tris(2,4-di-tert-butylphenyl) phosphite, bis(2,6-di-tert-butyl-4-methylphenyl) pentaerythritol diphosphite, or tetrakis(2,4-di-tert-butylphenyl)-4,4′-biphenylene diphosphonite is used. The content of the phosphorus-based heat stabilizer to the polycarbonate resin, relative to 100 parts by weight of the thermoplastic resin, is preferably 0.001 to 0.2 parts by weight.

A particularly preferable sulfur-based heat stabilizer is pentaerythritol-tetrakis(3-lauryl thiopropionate). The content of the sulfur-based heat stabilizer to the thermoplastic resin, relative to 100 parts by weight of the thermoplastic resin, is preferably 0.001 to 0.2 parts by weight.

Preferable hindered phenol-based heat stabilizers are octadecyl-3-(3,5-di-tert-butyl-4-hydroxy phenyl)propionate and pentaerythritol-tetrakis[3-(3,5-di-tert-butyl-4-hydroxyphenyl)propionate].

The content of the hindered phenol-based heat stabilizer in the thermoplastic resin, relative to 100 parts by weight of the thermoplastic resin, is preferably 0.001 to 0.3 parts by weight.

A phosphorus-based heat stabilizer and a hindered phenol-based heat stabilizer can be used in combination.

The ultraviolet absorber is preferably at least one ultraviolet absorber selected from the group consisting of benzotriazole-based ultraviolet absorbers, benzophenone-based ultraviolet absorbers, triazine-based ultraviolet absorbers, cyclic imino ester-based ultraviolet absorbers, and cyanoacrylate-based ultraviolet absorbers.

Of the benzotriazole-based ultraviolet absorbers, 2-(2-hydroxy-5-tert-octylphenyl)benzotriazole and 2,2′-methylenebis[4-(1,1,3,3-tetramethylbutyl)-6-(2H-benzotriazol-2-yl)phenol] are more preferable.

Examples of the benzophenone-based ultraviolet absorber include 2-hydroxy-4-n-dodecyloxybenzophenone and 2-hydroxy-4-methoxy-2′-carboxybenzophenone.

Examples of the triazine-based ultraviolet absorber include 2-(4,6-diphenyl-1,3,5-triazin-2-yl)-5-[(hexyl)oxy]-phenol and 2-(4,6-bis(2,4-dimethylphenyl)-1,3,5-triazin-2-yl)-5-[(octyl)oxy]-phenol.

As the cyclic imino ester-based ultraviolet absorber. 2,2′-p-phenylenebis(3,1-benzoxazin-4-one) is particularly suitable.

Examples of the cyanoacrylate-based ultraviolet absorber include 1,3-bis-[(2′-cyano-3′,3′-diphenylacryloyl)oxy]-2,2-bis[(2-cyano-3,3-diphenylacryloyl)oxy]methyl)propane and 1,3-bis-[(2-cyano-3,3-diphenylacryloyl)oxy]benzene.

The blending amount of the ultraviolet absorber, relative to 100 parts by weight of the thermoplastic resin, is preferably 0.01 to 3.0 parts by weight. In such a range of blending amount, a molded article of the thermoplastic resin can be imparted with sufficient weather resistance, depending on the application.

Examples of the antioxidant include triethylene glycol-bis[3-(3-tert-butyl-5-methyl-4-hydroxyphenyl)propionate], 1,6-hexanediol-bis[3-(3,5-di-tert-butyl-4-hydroxyphenyl)propionate], pentaerythritol-tetrakis[3-(3,5-di-tert-butyl-4-hydroxyphenyl)propionate], octadecyl-3-(3,5-di-tert-butyl-4-hydroxyphenyl)propionate, 1,3,5-trimethyl-2,4,6-tris(3,5-di-tert-butyl-4-hydroxybenzyl)benzene, N,N-hexamethylenebis(3,5-di-tert-butyl-4-hydroxy-hydrocinnamide). 3,5-di-tert-butyl-4-hydroxy-benzylphosphonate-diethyl ester, tris(3,5-di-tert-butyl-4-hydroxybenzyl)isocyanurate, and 3,9-bis{1,1-dimethyl-2-[β-(3-tert-butyl-4-hydroxy-5-methylphenyl)propionyloxy]ethyl}-2,4,8,10-tetraoxaspiro[5,5]undecane. The blending amount of the antioxidant, relative to 100 parts by mass of the thermoplastic resin composition, is preferably 0.50 parts by mass or less, more preferably 0.05 to 0.40 parts by mass, even more preferably 0.05 to 0.20 parts by mass or 0.10 to 0.40 parts by mass, and particularly preferably 0.20 to 0.40 parts by mass.

### <Optical Member>

The optical member of the present invention comprises the above thermoplastic resin. For the optical applications where the above thermoplastic resin is useful, examples of such an optical member can include, but are not limited to, optical disks, transparent conductive boards, optical cards, sheets, films, optical fibers, lenses, prisms, optical membranes, bases, optical filters, and hard coatings.

The optical member of the present invention may be composed of a resin composition comprising the above thermoplastic resin. The resin composition can be blended with an additive such as a heat stabilizer, a plasticizer, a photostabilizer, a polymeric metal deactivator, a flame retardant, a lubricant, an antistatic agent, a surfactant, an antibacterial agent, an ultraviolet absorber, a mold release agent, a bluing agent, a filler, and an antioxidant, as needed.

### <Optical Lens>

Examples of the optical member of the present invention can include, in particular, optical lenses. Examples of such optical lenses can include imaging lenses for mobile phones, smartphones, tablet terminals, personal computers, digital cameras, video cameras, in-vehicle cameras, and surveillance cameras, and those in sensing cameras such as TOF cameras.

When manufacturing the optical lens of the present invention by injection molding, molding is preferably under the conditions of a cylinder temperature of 230 to 350° C. and a die temperature of 70 to 180° C. Even more preferably, molding is preferably under the conditions of a cylinder temperature of 250 to 300° C. and a die temperature of 80 to 170° C. If the cylinder temperature is higher than 350° C., the thermoplastic resin is decomposed and discolored, and if lower than 230° C., the melt viscosity increases and molding is likely more difficult. If the die temperature is higher than 180° C., a molded piece composed of the thermoplastic resin is likely more difficult to remove from the die. If the die temperature is lower than 70° C. the resin hardens too quickly in the die during molding, the shape of the molded piece is more difficult to control, and sufficiently transferring an imprint applied to the die is likely more difficult.

The optical lens of the present invention is suitably carried out using the shape of an aspherical lens, as needed. Since an aspherical lens can substantially eliminate spherical aberration with a single lens, there is no need to remove spherical aberration by a combination of a plurality of spherical lenses, and reductions in weight and molding cost are possible. Therefore, aspherical lenses are useful particularly as camera lenses among optical lenses.

The thermoplastic resin of the present invention has high molding fluidity, and is thus particularly useful as a material of an optical lens that is thin and small and has a complex shape. As a specific lens size, the thickness of the center portion is 0.05 to 3.0 mm, more preferably 0.05 to 2.0 mm, and even more preferably 0.1 to 2.0 mm. The diameter is 1.0 mm to 20.0 mm, more preferably 1.0 to 10.0 mm, and even more preferably 3.0 to 10.0 mm. The shape thereof is preferably of a meniscus lens in which one side is convex and one side is concave.

A lens composed of the thermoplastic resin of the present invention is molded by any method such as die molding, cutting, polishing, laser processing, electric discharge machining, or etching. From the view of manufacturing cost, die molding is more preferable.

The present invention will be further specifically described by the following Examples. However, the present invention is not limited thereto.

### EXAMPLES

Evaluations were carried out using the following methods.

### <Thermoplastic Resin Composition>

The copolymerization ratio of each thermoplastic resin was calculated by H NMR measurement using a JNM-ECZ400S manufactured by JEOL Ltd.

### <Refractive Index>

A 3 mm-thick test piece of each thermoplastic resin was prepared and polished, and then measured for refractive index nd (587.56 nm) using a Kalnew Precision Refractometer KPR-2000 manufactured by Shimadzu Corporation.

### <Abbe Number>

The Abbe number (vd) was calculated at temperature: 20° C. and refractive indices at wavelengths: 486.13 nm, 587.56 nm, and 656.27 nm, using the following formula.

vd=(nd−1)/(nF−nC)
nd: refractive index at wavelength of 587.56 nm
nF: refractive index at wavelength of 486.13 nm
nC: refractive index at wavelength of 656.27 nm

### <Absolute Value of Orientation Birefringence>

The thermoplastic resin was dissolved in methylene chloride, then cast onto a glass petri dish, and sufficiently dried to produce a cast film having a thickness of 100 μm. The film was stretched two-fold at Tg+10° C., the retardation (Re) at 589 nm was measured using an ellipsometer M-220 manufactured by JASCO Corporation, and an absolute value of the orientation birefringence (|Δn|) was determined by the following formula.

|Δn|=|Re/d|
Δn: orientation birefringence
Re: retardation (nm)
d: thickness (nm)

### «Glass Transition Temperature (Tg)>

The obtained thermoplastic resin was measured with a Discovery DSC 25 Auto model manufactured by TA Instruments Japan Inc. at a temperature increase rate of 20° C./min. Samples were measured at 5 to 10 mg.

### Example 1

197.33 g (0.45 mol) of 9,9″-bis[4-(2-hydroxyethoxy)phenyl]fluorene (hereinafter, may be abbreviated as BPEF). 7.61 g (0.03 mol) of 3,9-bis(2-hydroxy-1,1-dimethylethyl)-2,4,8,10-tetraoxaspiro[5.5]undecane (hereinafter, may be abbreviated as SPG), 7.76 g (0.03 mol) of 4,4′-(3,3,5-trimethylcyclohexylidene)bisphenol (hereinafter, may be abbreviated as BisTMC), 109.25 g (0.51 mol) of diphenyl carbonate, and as a catalyst, 62.5 μL of a sodium hydrogen carbonate aqueous solution at a concentration of 40 mmol/L (2.5 μmol of sodium hydrogen carbonate) and 54.7 μL of a tetramethylammonium hydroxide aqueous solution at a concentration of 274 mmol/L (15 μmol of tetramethylammonium hydroxide) were heated and melted at 180° C. in a nitrogen atmosphere. The degree of pressure reduction was then adjusted to 20 kPa over a period of 10 minutes. The temperature was increased to 250° C. at a rate of 60° C./hr. After the outflowing amount of phenol reached 70%, the reactor internal pressure was lowered to 133 kPa over a period of 1 hour. Stirring was carried out for a total of 3.5 hours, and after the reaction was completed, the resin was removed. The copolymerization ratio of the obtained polycarbonate resin was measured by ¹H NMR. The refractive index, Abbe number, absolute value of orientation birefringence, and Tg of the polycarbonate resin were evaluated.

### Examples 2 to 5

Except that the monomer ratio was changed so that the copolymerization ratio of BPEF to SPG to BisTMC was as described in Table 1, a polycarbonate resin was manufactured in the same manner as in Example 1.

### Comparative Examples 1 to 4

Except that the monomer ratio was changed so that the copolymerization ratio of BPEF to SPG to BisTMC was as described in Table 1, a polycarbonate resin was manufactured in the same manner as in Example 1.

### <Results>

The configurations of the Examples and Comparative Examples and the evaluation results thereof were summarized in the following Table 1.

TABLE 1

| | | | | Evaluation results | | | |
|---|---|---|---|---|---|---|---|
| | | | | | | Birefringence | |
| | Copolymerization ratio (mol %) | | | Refractive | Abbe | \|Δn\| × | Tg |
| | BPEF | SPG | BisTMC | index nd | number νd | 10⁻³ | ° C. |
| Example 1 | 90 | 5 | 5 | 1.629 | 25.0 | 0.7 | 146 |
| Example 2 | 85 | 10 | 5 | 1.624 | 25.8 | 0.6 | 145 |
| Example 3 | 75 | 15 | 10 | 1.615 | 25.5 | 0.2 | 144 |
| Example 4 | 65 | 20 | 15 | 1.605 | 27.9 | 0.2 | 149 |
| Example 5 | 60 | 10 | 30 | 1.603 | 28.2 | 0.3 | 149 |
| Comparative Example 1 | 30 | 35 | 35 | 1.563 | 32.3 | 3.8 | 149 |
| Comparative Example 2 | 20 | 45 | 35 | 1.546 | 34.9 | 4.4 | 145 |
| Comparative Example 3 | 60 | 0 | 40 | 1.604 | 27.6 | 0.5 | 164 |
| Comparative Example 4 | 60 | 40 | 0 | 1.590 | 30.3 | 0.1 | 129 |

BPEF: 9,9-bis[4-(2-hydroxyethoxy)phenyl]fluorene
SPG: 3,9-bis(2-hydroxy-1,1-dimethylethyl)-2,4,8,10-tetraoxaspiro[5.5]undecane
BisTMC: 4,4′-(3,3,5-trimethylcyclohexylidene)bisphenol

Examples 1 to 5 were able to satisfy all of the refractive index of about 1.600 to 1.660, Abbe number, low birefringence, and heat resistance.

Comparative Examples 1 and 2 both exemplified a polycarbonate resin consisting of BPEF, SPG, and BisTMC. However, since the proportions of BPEF were small, the refractive indices and birefringence were insufficient compared to the Examples.

Comparative Example 3 exemplified a polycarbonate resin consisting of BPEF and BisTMC. However, since SPG was not contained, Tg was high compared to those of the Examples, and the polycarbonate resin was not suitable for use as a molding material.

Comparative Example 4 exemplified a polycarbonate resin consisting of BPEF and SPG. However, since BisTMC was not contained, Tg was low compared to those of the Examples, and heat resistance was insufficient.

### INDUSTRIAL APPLICABILITY

The thermoplastic resin of the present invention is used in optical materials, can be used in optical members such as optical lenses, prisms, optical disks, transparent conductive boards, optical cards, sheets, films, optical fibers, optical membranes, optical filters, and hard coatings, and is very useful particularly in optical lenses.

1. A thermoplastic resin comprising repeating units represented by Formula (1), Formula (2), and Formula (3), wherein the repeating unit represented by the Formula (1) is 60 mol % or greater and a refractive index is greater than 1.600 and 1.660 or less: 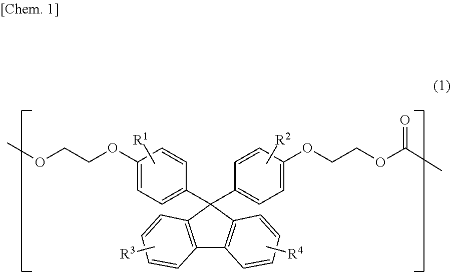
where in the Formula (1), R¹ to R⁴ each independently represent a hydrogen atom or a hydrocarbon group having 1 to 10 carbon atoms, and 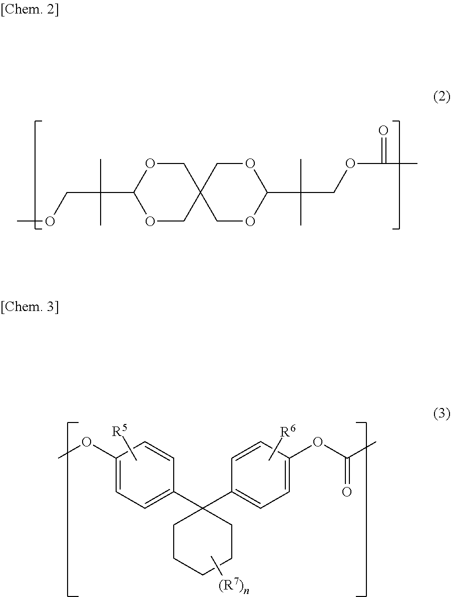
where in the Formula (3), n is in a range of 1 to 8; R⁵ and R⁶ each independently represent a hydrogen atom or a hydrocarbon group having 1 to 10 carbon atoms; and R⁷ represents a hydrogen atom or an alkyl group having 1 to 3 carbon atoms.

2. The thermoplastic resin according to claim 1, wherein the repeating unit of the Formula (1) is 60 mol % or greater and 80 mol % or less.

3. The thermoplastic resin according to claim 1, wherein R¹ to R⁴ in the Formula (1) are each a hydrogen atom.

4. The thermoplastic resin according to claim 1, wherein the repeating unit of the Formula (3) is a repeating unit derived from 4,4′-(3,3,5-trimethylcyclohexylidene)bisphenol.

5. The thermoplastic resin according to claim 1, which has a glass transition temperature of 130 to 160° C.

6. The thermoplastic resin according to claim 1, which has an absolute value of orientation birefringence of 3.0×10⁻³ or less.

7. The thermoplastic resin according to claim 1, which has an absolute value of orientation birefringence of 1.0×10⁻³ or less.

8. The thermoplastic resin according to claim 1, which has an Abbe number of 24.0 to 29.0.

9. An optical member comprising the thermoplastic resin according to claim 1.

10. The optical member according to claim 9, which is an optical lens.
